(19) United States
(12) Patent Application Publication
(10) Pub. No.: US 2026/0127638 A1
(43) Pub. Date: May 7, 2026

(54) MACHINE LEARNING BASED APPROACH FOR OPTIMIZING TARGETED MESSAGING BASED ON PERSONA CLUSTER IN AN ENTERPRISE APPLICATION

(71) Applicant: Dell Products L.P., Round Rock, TX (US)

(72) Inventors: Abhishek Mishra, Bangalore (IN); Dev Kathuria, Greater Noida (IN); David Sydow, Merrimack, NH (US); Vivek Bhargava, Bangalore (IN); Ajith Navada, Davangore District (IN)

(73) Assignee: Dell Products L.P., Round Rock, TX (US)

(21) Appl. No.: 18/937,288

(22) Filed: Nov. 5, 2024

(51) Int. Cl. G06Q 30/0251

(52) U.S. Cl. CPC G06Q 30/0269; G06Q 30/0261

(57) ABSTRACT

Methods, system, and non-transitory processor-readable storage medium for email targeting system are provided herein. An example method includes receiving by an email server system, from an email client system, an email campaign intended for a plurality of recipients. The email targeting system categorizes each of the plurality of recipients into recipient behavior classifications based on previous recipient behavior responding to previous email campaigns. The email targeting system generates a personalized templated email communication for each of recipient behavior classifications, to replace the email campaign, where the email targeting system uses the email campaign, a large language model, and the recipient behavior classifications to generate the personalized templated email.

### FIELD

The field relates generally to optimizing email campaigns by optimizing and targeting the messaging.

### BACKGROUND

Large enterprise companies typically receive various types of communications that are daily sent either for internal communication or is intended for customer communication.

### SUMMARY

Illustrative embodiments provide techniques for implementing an email targeting system in a storage system. For example, in illustrative embodiments, an email server system receives from an email client system, an email campaign intended for a plurality of recipients. An email targeting system categorizes each of the plurality of recipients into recipient behavior classifications based on previous recipient behavior responding to previous email campaigns. The email targeting system generates a personalized templated email communication for each of recipient behavior classifications, to replace the email campaign, where the email targeting system uses the email campaign, a large language model, and the recipient behavior classifications to generate the personalized templated email communication. Other types of processing devices can be used in other embodiments. These and other illustrative embodiments include, without limitation, apparatus, systems, methods and processor-readable storage media.

### BRIEF DESCRIPTION OF THE DRAWINGS

FIG. 1 shows an information processing system including an email targeting system, in an illustrative embodiment.

FIG. 2 shows a flow diagram of a process for an email targeting system, in an illustrative embodiment.

FIG. 3 illustrates an email delivery report, in an illustrative embodiment.

FIG. 4 illustrates business unit email delivery report, in an illustrative embodiment.

FIG. 5 illustrates a demography email report, in an illustrative embodiment.

FIG. 6 illustrates an email open rate report, in an illustrative embodiment.

FIGS. 7 and 8 show examples of processing platforms that may be utilized to implement at least a portion of an email targeting system embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Described below is a technique for use in implementing an email targeting system, which technique may be used to generate targeted messaging for recipients of an email campaign. An email server system receives from an email client system, an email campaign intended for a plurality of recipients. An email targeting system categorizes each of the plurality of recipients into recipient behavior classifications based on previous recipient behavior responding to previous email campaigns. The email targeting system generates a personalized templated email communication for each of recipient behavior classifications, to replace the email campaign, where the email targeting system uses the email campaign, a large language model, and the recipient behavior classifications to generate the personalized templated email communication.

Prior to sending out email campaigns, there are validations processes such as proof reading, localization, and message content review that need to be completed. In addition, there are major stakeholders involved in the end-to-end process. These stakeholders include the marketing and communication teams, who are responsible for content generation and review, the communication development team who is responsible for triggering the communication, and the end-user (i.e., the recipient) who will receive the email campaign.

The most critical problem that can hinder the generation of succinct, relevant, and targeted email campaigns is that there are many siloed layers of approval and guidelines required for content generation. For example, the addition of company messaging templates and guidelines (color schemes, font, verbiage, etc.) into the communication, and the generation of layered user context may have thousands of patterns that require the right content to be sent according to specific behavior patterns for a user.

Conventional technologies that manually create and maintain mass emailing lists are not scalable and lead to cluttered inboxes for the recipients, with the possibility that the email recipients will ignore potentially relevant and important emails. Conventional technologies that send out email campaigns do not target email campaigns based on the previous recipient behavior to prior email campaigns. Conventional technologies do not provide a machine learning based approach for identifying and rating critical messaging and verbiage in a messaging context, utilizing recipient messaging reading patterns, actions, message delivery data, and then groups the date into user/recipient personas. Conventional technologies do not provide algorithms that evaluate and group recipient messaging body and data, and then generate recommendations for a relevant email/messaging content. Conventional technologies do not collect and evaluate recipient behavior to optimize email campaigns to provide relevant communication to the recipients.

By contrast, in at least some implementations in accordance with the current technique as described herein, an email server system receives from an email client system, an email campaign intended for a plurality of recipients. An email targeting system categorizes each of the plurality of recipients into recipient behavior classifications based on previous recipient behavior responding to previous email campaigns. The email targeting system generates a personalized templated email communication for each of recipient behavior classifications, to replace the email campaign, where the email targeting system uses the email campaign, a large language model, and the recipient behavior classifications to generate the personalized templated email communication.

Thus, a goal of the current technique is to provide a method and a system for providing an email targeting system that optimizes targeted email messaging based on persona cluster. Another goal is to target email campaigns based on the previous recipient behavior to prior email campaigns. Another goal is to provide a machine learning based approach for identifying and rating critical messaging and verbiage in a messaging context, utilizing recipient messaging reading patterns, actions, message delivery data, and then group the date into user/recipient personas. Another goal is to provide algorithms that evaluate and group recipient messaging body and data, and then generate recommendations for a relevant email/messaging content. Yet another goal is to collect and evaluate recipient behavior to optimize email campaigns to provide relevant communication to the recipients.

In at least some implementations in accordance with the current technique described herein, the use of an email targeting system can provide one or more of the following advantages: providing a method and a system for providing an email targeting system that optimizes targeted email messaging based on persona cluster, targeting email campaigns based on the previous recipient behavior to prior email campaigns, providing a machine learning based approach for identifying and rating critical messaging and verbiage in a messaging context, utilizing recipient messaging reading patterns, actions, message delivery data, and then grouping the date into user/recipient personas, providing algorithms that evaluate and group recipient messaging body and data, and then generating recommendations for a relevant email/messaging content, and collecting and evaluating recipient behavior to optimize email campaigns to provide relevant communication to the recipients.

In contrast to conventional technologies, in at least some implementations in accordance with the current technique as described herein, an email targeting system generates optimized targeted messaging for recipients of an email campaign. An email server system receives from an email client system, an email campaign intended for a plurality of recipients. An email targeting system categorizes each of the plurality of recipients into recipient behavior classifications based on previous recipient behavior responding to previous email campaigns. The email targeting system generates a personalized templated email communication for each of recipient behavior classifications, to replace the email campaign, where the email targeting system uses the email campaign, a large language model, and the recipient behavior classifications to generate the personalized templated email communication.

In an example embodiment of the current technique, the previous recipient behavior is associated with the plurality of recipients.

In an example embodiment of the current technique, the email targeting system intercepts the email campaign at the email server system.

In an example embodiment of the current technique, the email targeting system compiles message analytics, where the message analytics comprise at least one of read receipts and sent receipts associated with the previous email campaigns.

In an example embodiment of the current technique, the email targeting system compiles user data, where the user data comprises at least one of geographic location data and average email reading time associated with the previous email campaigns.

In an example embodiment of the current technique, the email targeting system identifies unique footprints in metadata associated with the previous email campaigns.

In an example embodiment of the current technique, the email targeting system compiles historical data associated with the previous email campaigns.

In an example embodiment of the current technique, the email targeting system categorizes the plurality of recipients according to at least one of an opening classification and a reading classification.

In an example embodiment of the current technique, the email targeting system categorizes the plurality of recipients according to an opening classification, where the opening classification indicates how likely a recipient is to open an email relative to other recipients, and where the opening classification comprises a mostly-ignores-email classification, a sometimes-ignores-email classification, and a usually-opens-email classification.

In an example embodiment of the current technique, for each email in a plurality of email campaigns received by a recipient, where the plurality of recipients comprises the recipient, the email targeting system determines whether the recipient opened each email, determines a percentage of opened emails for recipients receiving email from the plurality of email campaigns, based on geographical data associated with the recipient, determines how much time the recipient spent reading each email, determines an average time spent reading each email by the recipients receiving email from the plurality of email campaigns, and records a non-opened-email value if the recipient did not open each email.

In an example embodiment of the current technique, the email targeting system classifies the recipient as having ignored the email based on whether the recipient opened the email and the percentage of opened emails for the recipients receiving email from the plurality of email campaigns, based on the geographical data associated with the recipient.

In an example embodiment of the current technique, the email targeting system classifies the recipient in one of the opening classifications based on whether the recipient opened each email and the percentage of opened emails for the recipients receiving email from the plurality of email campaigns, based on the geographical data associated with the recipient.

In an example embodiment of the current technique, the email targeting system categorizes the plurality of recipients according to a reading classification, where the reading classification indicates how much time a recipient typically spends reading an email relative to other recipients, where the reading classification comprises a minimal time reading classification, an average time reading classification, and an extra time reading classification.

In an example embodiment of the current technique, the email targeting system determines a standard deviation associated with the recipient's reading time for each email in a plurality of email campaigns opened by the recipient, and classifies the recipient into the reading classification according to the standard deviation.

In an example embodiment of the current technique, the email targeting system provides the large language model with the email campaign, prompting the large language model to generate a more concise email campaign, prompting the large language model to generate a more verbose email campaign, prompting the large language model to generate a strongly worded email header for the email campaign, and prompting the large language model to generate a general email header for the email campaign.

In an example embodiment of the current technique, for each recipient in the plurality of recipient categorized by the email targeting system with an opening classification of mostly-ignores-email classification, the email targeting system appends the strongly worded email header, and for each recipient in the plurality of recipient categorized by the email targeting system with an opening classification of sometimes-ignores-email classification, or usually-opens-email classification, the email targeting system appends the general email header.

In an example embodiment of the current technique, for each recipient in the plurality of recipient categorized by the email targeting system with a reading classification of minimal time reading classification, the email targeting system appends the more concise email campaign, and for each recipient in the plurality of recipient categorized by the email targeting system with a reading classification of extra time reading classification, the email targeting system appends the more verbose email campaign.

In an example embodiment of the current technique, the email targeting system transmits the personalized templated email communications back to the email client system or review by at least one author of the email campaign.

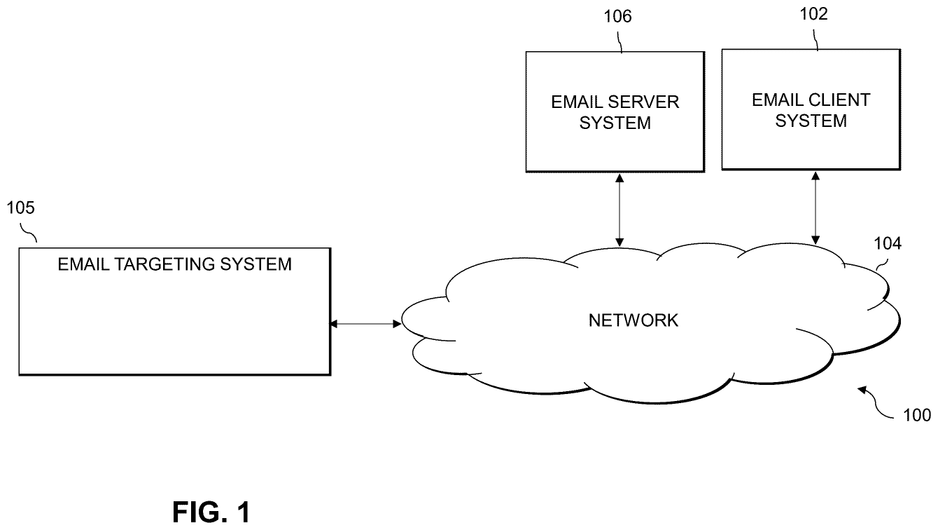

FIG. 1 shows a computer network (also referred to herein as an information processing system) 100 configured in accordance with an illustrative embodiment. The computer network 100 comprises an email targeting system 105, email server system 106, and email client system 102. The email targeting system 105, email server system 106, and email client system 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is an email targeting system 105 that may reside on a storage system. Such storage systems can comprise any of a variety of different types of storage including network-attached storage (NAS), storage area networks (SANs), direct-attached storage (DAS) and distributed DAS, as well as combinations of these and other storage types, including software-defined storage.

Each of the email targeting system 105, email server system 106, and email client system 102 may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The email targeting system 105, email server system 106, and email client system 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the email targeting system 105 are one or more input-output devices, which illustratively comprise keyboards, displays or other types of input-output devices in any combination. Such input-output devices can be used, for example, to support one or more user interfaces to the email targeting system 105, as well as to support communication between the email targeting system 105 and other related systems and devices not explicitly shown. For example, a dashboard may be provided for a user to view a progression of the execution of the email targeting system 105. One or more input-output devices may also be associated with any of the email targeting system 105, email server system 106, and email client system 102.

Additionally, the email targeting system 105 in the FIG. 1 embodiment is assumed to be implemented using at least one processing device. Each such processing device generally comprises at least one processor and an associated memory, and implements one or more functional modules for controlling certain features of the email targeting system 105.

More particularly, the email targeting system 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the email targeting system 105 to communicate over the network 104 with the email server system 106, and email client system 102 and illustratively comprises one or more conventional transceivers.

An email targeting system 105 may be implemented at least in part in the form of software that is stored in memory and executed by a processor, and may reside in any processing device. The email targeting system 105 may be a standalone plugin that may be included within a processing device.

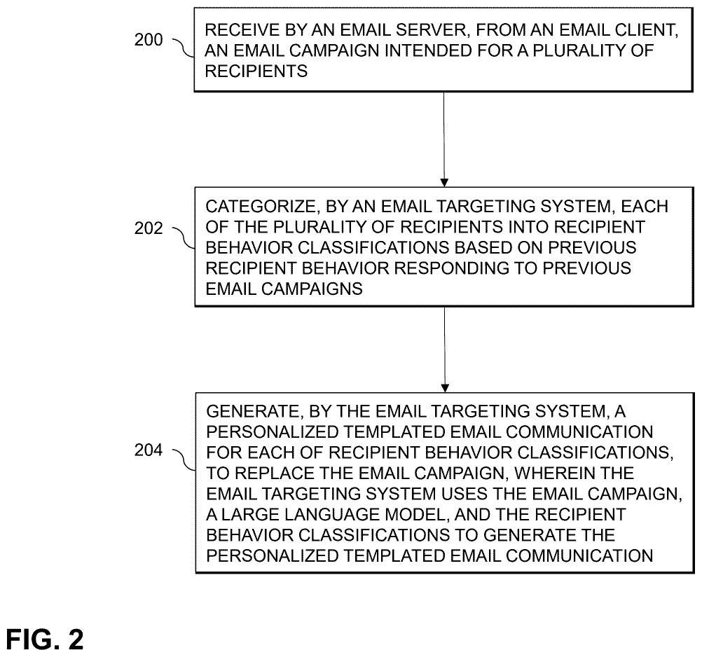

It is to be understood that the particular set of elements shown in FIG. 1 for email targeting system 105 involving the email targeting system 105, email server system 106, and email client system 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the email targeting system 105 can be on and/or part of the same processing platform. An exemplary process of email targeting system 105 in computer network 100 will be described in more detail with reference to, for example, the flow diagram of FIG. 2.

FIG. 2 is a flow diagram of a process for execution of the email targeting system 105 in an illustrative embodiment. It is to be understood that this particular process is only an example, and additional or alternative processes can be carried out in other embodiments.

At 200, an email client system 102 transmits an email campaign to an email server system 106 intended for a plurality of recipients. The email campaign is received by the email server system 106. In an example embodiment, the email targeting system 105 intercepts the email campaign at the email server system 106.

At 202, the email targeting system 105 categorizes each of the plurality of recipients into recipient behavior classifications based on previous recipient behavior responding to previous email campaigns. The previous recipient behavior is based on previous email campaigns. In an example embodiment, the email targeting system 105 compiles historical data associated with the previous email campaigns. Once an email campaign is received by the recipients, the email targeting system 105 metrics collection begins, collecting data such as delivery receipt, and capturing recipient actions, such as read receipts, call to action (CTA), recipient clicks, and clickstream data of notification. In an example embodiment, the previous recipient behavior is associated with the respective plurality of recipients. In another example embodiment, the previous recipient behavior is associated with multiple respective pluralities of recipients. In an example embodiment, the statistics from previous email campaigns may be collected for up to one year. These statistics include both the campaign successes and campaign failures. In an example embodiment, the time period of one year is selected to account for typical company attrition and reorganization, which can change the behavior patterns of the recipients.

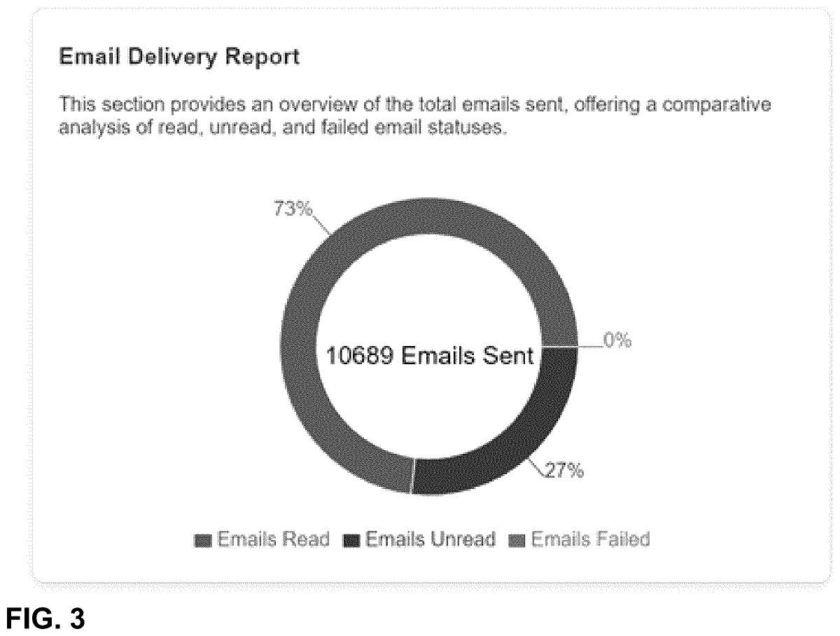

In an example embodiment, the email targeting system 105 compiles message analytics, where the message analytics comprise at least one of read receipts and sent receipts associated with the previous email campaigns. The data collected may include, for example, the total number of emails sent in the email campaign, the number of emails read, the number of emails unread, and the number of emails that failed. FIG. 3 illustrates an email delivery report, where, for example, an email campaign has been triggered to 10,869 recipients. Of those recipients, 73% have read (i.e., opened) the email, and 27% have not read (i.e., opened) the email.

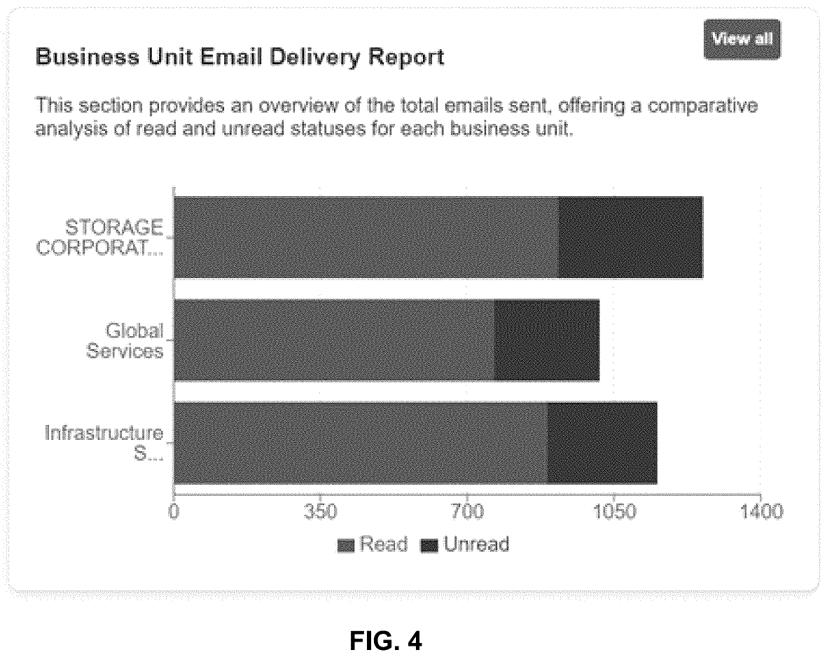

In another example embodiment, the data may include a business unit delivery report, providing data on how many emails were sent, offering a comparative analysis of read and unread emails for each business unit. FIG. 4 illustrates business unit email delivery report that shows the number of read and unread emails, according to different business units. In an example embodiment, the message analytics are collected for use by Artificial Intelligence/Machine Learning (AI/ML) algorithms.

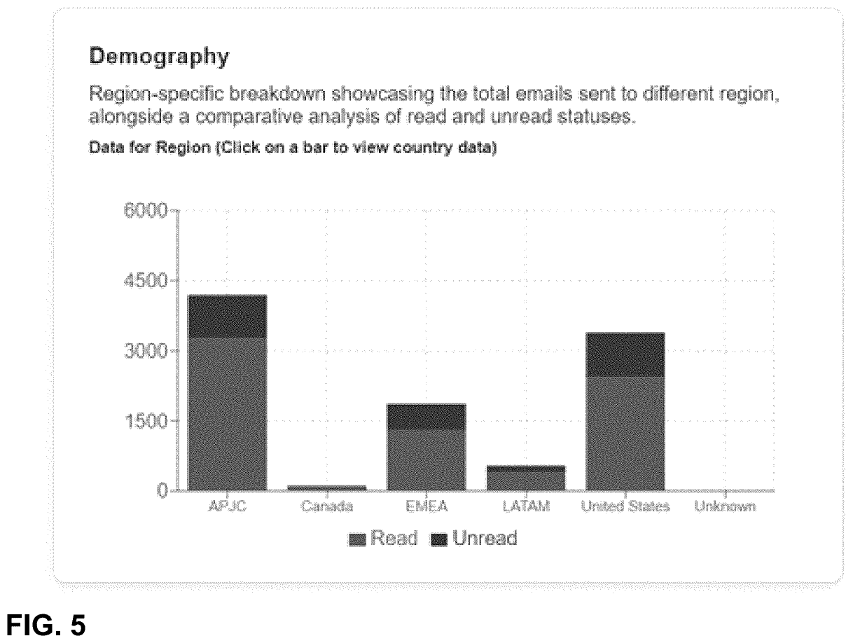

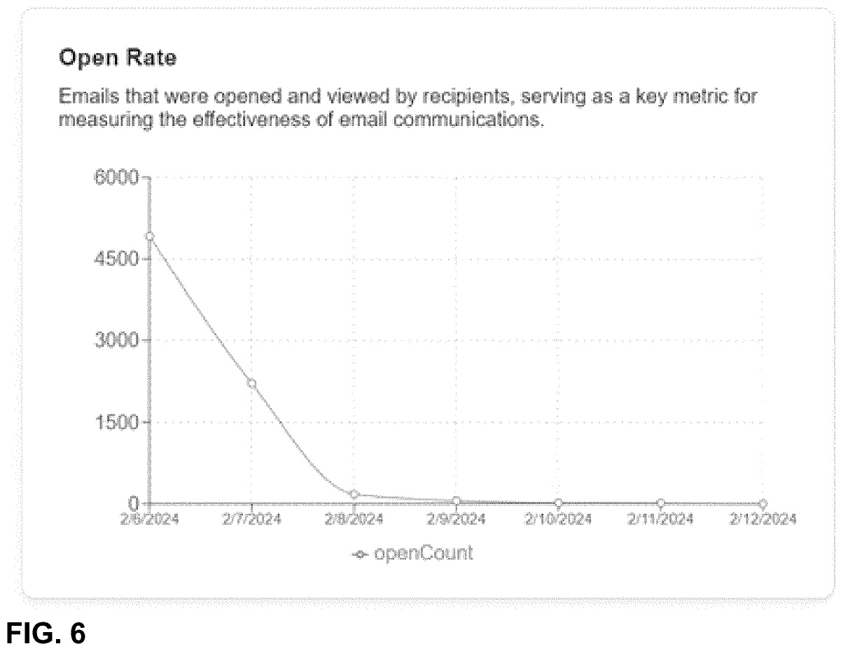

In an example embodiment, the email targeting system 105 compiles user data, where the user data comprises at least one of geographic location data and average email reading time associated with the previous email campaigns. In an example embodiment, the geographic location data details which regions have the most activity and which region has the highest rate of read messages. FIG. 5 illustrates a demography email report, detailing a region-specific breakdown of read emails and emails that were not read. The geographic location data may also contain statistics on how many emails were opened and viewed by recipients, serving as a key metric for measuring the effectiveness of email campaigns. FIG. 6 illustrates an email open rate report, detailing the effectiveness of email campaigns, by showing the email open rate according to a timeline. In an example embodiment, the email targeting system 105 also captures the average time spent reading the email.

In an example embodiment, the email targeting system 105 performs data wrangling by identifying unique footprints in metadata associated with the previous email campaigns. In an example embodiment, once the analytics and metadata have been collected, an indexing is performed across all the messages data for those transactions with similar Internet Protocol (IP) footprints and patterns in the metadata, and also to identify unique footprints in the metadata.

In an example embodiment, the email targeting system 105 categorizes the plurality of recipients according to at least one of an opening classification and a reading classification. In an example embodiment, prior to sending out a new email campaign, every recipient is classified into an opening classification and a reading classification based on their previous behavior when receiving previous email campaigns.

In an example embodiment, the email targeting system 105 categorizes the plurality of recipients according to an opening classification, where the opening classification indicates how likely a recipient is to open an email relative to other recipients. The opening classification comprises a mostly-ignores-email classification, a sometimes-ignores-email classification, and a usually-opens-email classification.

In an example embodiment, the email targeting system 105 classifies the recipient as having ignored the email based on whether the recipient opened the email and the percentage of opened emails for the recipients receiving email from the plurality of email campaigns, based on the geographical data associated with the recipient. In an example embodiment, the email targeting system 105 classifies the recipient in the opening classification (i.e., mostly-ignores-email classification, sometimes-ignores-email classification, and usually-opens-email classification) using an opening classification algorithm. In an example embodiment, for each email in a plurality of email campaigns received by a recipient (where the plurality of recipients comprises the recipient), the email targeting system 105 determines whether the recipient opened the email. The email targeting system 105 determines a percentage of opened emails for recipients receiving email from the plurality of email campaigns, based on geographical data associated with the recipient. The email targeting system 105 determines how much time the recipient spent reading the email. In an example embodiment, the time is recorded in minutes. The email targeting system 105 determines an average time spent reading the email by the recipients receiving the email from the plurality of email campaigns. The email targeting system 105 records a non-opened-email value if the recipient did not open the email. In an example embodiment, the non-opened-email value is “N/A”. In an example embodiment, the email targeting system 105 creates an email frequency opening list as illustrated below:

| User: John Doe | | | Geo: AMEA | |
|---|---|---|---|---|
| | Opened (1 yes, | Average Open | User Time | Average Time |
| Mail Date | 0 no) | Percent | Reading | Reading (minutes) |
| Mar. 1, 2023 | 0 | 20 | N/A | 5 |
| Apr. 6, 2023 | 0 | 21 | N/A | 3 |
| Nov. 9, 2023 | 0 | 43 | N/A | 4 |
| Jan. 8, 2024 | 1 | 68 | 2 | 1 |
| Feb. 10, 2024 | 0 | 24 | N/A | 2 |
| Mar. 3, 2024 | 0 | 56 | N/A | 1 |

In an example embodiment, the email targeting system 105 creates an “Ignored Fields” table for the recipient, where the “Ignored Fields” table comprises an “Ignored” column. In an example embodiment, for each record in the email frequency opening list, the email targeting system 105 compares the “Opened” value against the “Average Open Percent” value. If the “Opened” value is 0, and the “Average Open Percent” value is greater than 50, the email targeting system 105 records the “Ignored” column as 1. Listed below is an example “Ignored Fields” table for User John Doe:

| | |
|---|---|
| User: John Doe | Geo: AMEA |

| | Opened (1 yes, | Average Open | |
|---|---|---|---|
| Mail Date | 0 no) | Percent | Ignored |
| Mar. 1, 2023 | 0 | 20 | 0 |
| Apr. 6, 2023 | 0 | 21 | 0 |
| Nov. 9, 2023 | 0 | 43 | 1 |
| Jan. 8, 2024 | 1 | 68 | 0 |
| Feb. 10, 2024 | 0 | 24 | 0 |
| Mar. 3, 2024 | 0 | 56 | 1 |

In an example embodiment, the email targeting system 105 classifies the recipient in one of the opening classifications based on whether the recipient opened the email and the percentage of opened emails for the recipients receiving email from the plurality of email campaigns, based on the geographical data associated with the recipient. In an example embodiment, the email targeting system 105 then classifies the recipient into the opening classification (i.e., mostly-ignores-email classification, sometimes-ignores-email classification, and usually-opens-email classification) using the following ignore state classification algorithm. The email targeting system 105 classifies recipients as “mostly-ignores-email” if over 60% of the “Ignored” column is marked as 1. The email targeting system 105 classifies recipients as sometimes-ignores-email if the “Ignored” column is marked as 1 between 40% and 60%. The email targeting system 105 classifies recipients as usually-opens-email if less than 40% of the “Ignored” column is marked as 1.

In an example embodiment, the email targeting system 105 creates an “Ignore Classification” table for the plurality of the recipients. An example is listed below:

| User | Classification | Percent Ignored |
|---|---|---|
| John Doe | Sometimes-Ignores-Mail | 55% |
| Jane Doe | Usually-Opens-Mail | 21% |
| Bill Smith | Mostly-Ignores-Mail | 76% |
| Cindy Smith | Sometimes-Ignores-Mail | 42% |

In an example embodiment, the email targeting system 105 categorizes the plurality of recipients according to a reading classification, where the reading classification indicates how much time a recipient typically spends reading an email relative to other recipients. In an example embodiment, the reading classification comprises a minimal time reading classification, an average time reading classification, and an extra time reading classification. In an example embodiment, for each record in the email frequency opening list, the email targeting system 105 determines a standard deviation associated with the recipient's reading time for each email in a plurality of email campaigns opened by the recipient. In an example embodiment, the formula for the standard deviation for a population is as follows:

$$σ = \sqrt{\sum \frac{{( {x}_{i} - U )}^{2}}{N}}$$

In the email frequency opening list, above, the values (i.e., Average Time Reading (minutes)) used are 5, 3, 4, 1, 2, and 1. Using the above formula, the standard deviation is ˜1.63.

In an example embodiment, the email targeting system 105 classifies the recipient into the reading classification according to the standard deviation. The email targeting system 105 subtracts 1 standard deviation from the Average Time Reading value for each record in the email frequency opening list. If the resulting number is a positive value, the email targeting system 105 compares the resulting value against the “User Reading Time” in the email frequency opening list. In an example embodiment, if the “User Reading Time” is higher than the “Average Time Reading”+1 standard deviation, then the recipient associated with that record is classified in the “Extra Reading Time” classification. In an example embodiment, if the “User Reading Time” is lower than the “Average Time Reading”−1 standard deviation, then the recipient associated with that record is classified in the “Minimal Reading Time” classification. In an example embodiment, if the “User Reading Time” is less than 1 standard deviation from the “Average Time Reading”, then the recipient associated with that record is classified in the “Average Reading Time” classification.

In an example embodiment, the email targeting system 105 provides a filter for the above algorithm. The email targeting system 105 subtracts 1 standard deviation from the Average Time Reading value for each record in the email frequency opening list. If the resulting number is a negative value, the Average Time Reading value is not considered further because this means the average reading time of the email is very short, and therefore, the data is not useful to the algorithm.

Listed below is a table that illustrates an example recipient, compares their reading time to the average reading time, and then provides a reading classification based on 1 standard deviation.

| | Geo: AMEA | | Standard |
|---|---|---|---|
| User: John Doe | Average | User | Deviation: ~1.63 |
| Mail Date | Reading Time | Reading Time | Classification |
| Mar. 1, 2023 | 5 | 1 | Minimal |
| | | | Reading Time |
| Apr. 6, 2023 | 3 | 1 | Minimal |
| | | | Reading Time |
| Nov. 9, 2023 | 4 | 3 | Average |
| | | | Reading Time |
| Jan. 8, 2024 | 1 | 2 | N/A |
| Feb. 10, 2024 | 2 | 7 | Extra |
| | | | Reading Time |
| Mar. 3, 2024 | 1 | 1 | N/A |

In an example embodiment, the email targeting system 105 classifies each recipient into a reading time state. The email targeting system 105 classifies each recipient following the majority labels across all the recipient's opened emails. For example, if the recipient opens 7 emails, with the following distribution, 3 “minimal reading time”, 2 “average reading time”, and 2 “extra reading time”, then the email targeting system 105 classifies that recipient overall as having “minimal reading time”. In an example embodiment, if the recipient has a distribution that is equal across multiple classifications, the email targeting system 105 classifies the recipient with the lowest reading time classification in the tie. For example, if there is a tie between “minimal reading time” and “average reading time”, then the email targeting system 105 classifies the recipient as “minimal reading time”.

In an example embodiment, once the email targeting system 105 has classified each recipient according to the opening classification and the reading classification, the email targeting system 105 creates a recipient classification table to capture the results of the classification algorithms. In an example embodiment, the email targeting system 105 creates a table for each pre-defined geographical area. An example of the recipient classification table is illustrated below:

| User | Opening Classification | Reading Classification |
|---|---|---|
| John Doe | Sometimes-Ignores-Mail | Average Reading Time |
| Jane Doe | Usually-Opens-Mail | Minimal Reading Time |
| Bill Smith | Mostly-Ignores-Mail | N/A |
| Cindy Smith | Sometimes-Ignores-Mail | Extra Reading Time |

At 204, the email targeting system 105 generates a personalized templated email communication for each of recipient behavior classifications, to replace the email campaign. The email targeting system 105 utilizes the email campaign, a large language model, and the recipient behavior classifications to generate the personalized templated email communication. In an example embodiment, a Mixtral-7B is used as the large language model.

In an example embodiment, the email campaign provides a generic email, such as:
“You have the following applications installed on your PC that are in violation of the security policy: MS Word, MS Excel, MS Access. The deadline to uninstall these applications is Apr. 1, 2024. If they are not uninstalled by that time, your PC will be taken off of the network for security violations”.

In an example embodiment, the email targeting system 105 provides the large language model with the email campaign (i.e., the generic email), as a prompt. The email targeting system 105 prompts the large language model to generate a more concise email campaign, for example, “Make the following message more concise”. In an example embodiment, the large language model responds with the following email:
“The following apps on your PC violate our security policy: MS Word, MS Excel, MS Access. Uninstall them by Apr. 1, 2024 to avoid network removal due to security violations”.

In an example embodiment, the email targeting system 105 prompts the large language model to generate a more verbose email campaign, for example, “Make the following message more verbose, and give links where appropriate”. In an example embodiment, the large language model responds with the following email:
“We hope this message finds you well. In our ongoing efforts to maintain a secure and compliant computing environment, we've conducted a recent audit of installed software across all company-owned PCs. During this audit, it has come to our attention that your PC currently has certain applications installed that do not align with our organization's security policy.
Specifically, the applications identified on your PC that are in breach of our security protocols include:
   Microsoft Word.
   Microsoft Excel
   Microsoft Access
For your reference and further action, please find more information on our security policy and the rationale behind the disallowance of certain applications on the official Security Policy Page.
Deadline for Action: Please be advised that the deadline for the uninstallation of these applications is set for Apr. 1, 2024. It is crucial that you adhere to this deadline to ensure your PC remains compliant with our security standards. Consequences of Inaction: Failure to uninstall these applications by the stated deadline will unfortunately result in your PC being disconnected from the network. This measure, while regrettable, is necessary to prevent potential security vulnerabilities that may arise from the continued presence of these applications on your PC.
Instructions for Uninstallation: To assist you in this process, we have prepared a step-by-step guide on how to uninstall software from your PC. Please visit our Software Uninstallation Guide for comprehensive instructions.
Need Assistance?: We understand that this process may be inconvenient, and our IT support team is here to help. Should you encounter any difficulties or require further clarification, please do not hesitate to contact our IT Support Team at ITSupport@yourcompany.com or by calling ext. 1234.
We appreciate your prompt attention to this matter and your cooperation in keeping our IT environment secure. Thank you for your understanding and for taking the necessary steps towards compliance”.

In an example embodiment, the email targeting system 105 prompts the large language model to generate a strongly worded email header for the email campaign, for example, “Make a title that sounds critical for the following information”. In an example embodiment, the large language model responds with the following email header, “Urgent Compliance Alert: Immediate Action Required for Unauthorized Applications”.

In an example embodiment, the email targeting system 105 prompts the large language model to generate a general email header for the email campaign, for example, “Make a title for the following information”. In an example embodiment, the large language model responds with the following email header, “Important Security Notice: Deadline for Uninstalling Prohibited Applications Approaching”.

In an example embodiment, for each recipient in the plurality of recipient categorized by the email targeting system 105 with an opening classification of mostly-ignores-email classification, the email targeting system 105 appends the strongly worded email header. In an example embodiment, for each recipient in the plurality of recipient categorized by the email targeting system 105 with an opening classification of sometimes-ignores-email classification, or usually-opens-email classification, the email targeting system 105 appends the general email header. In an example embodiment, for each recipient in the plurality of recipient categorized by the email targeting system 105 with a reading classification of minimal time reading classification, the email targeting system 105 appends the more concise email campaign. In an example embodiment, for each recipient in the plurality of recipient categorized by the email targeting system 105 with a reading classification of extra time reading classification, the email targeting system 105 appends the more verbose email campaign.

In an example embodiment, the email targeting system 105 transmits, the personalized templated email communications back to the email client system 102 for review by at least one author of the email campaign. In an example embodiment, the author can approve or rejected the personalized templated email communications. Once the author approves the personalized templated email communications, the email client system 102 transmits the personalized templated email communications back to the email targeting system 105.

In an example embodiment, the email targeting system 105 then transmits the personalized templated email communications, in place of the email campaign, to the email server system 106, where the personalized templated email communications are then transmitted from the email server system 106 to the respective plurality of recipients.

Accordingly, the particular processing operations and other functionality described in conjunction with the flow diagram of FIG. 2 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to provide a method and a system for providing an email targeting system that provides an email targeting system that optimizes targeted email messaging based on persona cluster. These and other embodiments can effectively improve targeted messaging for recipients of an email campaign. For example, embodiments disclosed herein target email campaigns based on the previous recipient behavior to prior email campaigns. Embodiments disclosed herein provide a machine learning based approach for identifying and rating critical messaging and verbiage in a messaging context, utilizing recipient messaging reading patterns, actions, message delivery data, and then group the date into user/recipient personas. Embodiments disclosed herein provide algorithms that evaluate and group recipient messaging body and data, and then generate recommendations for a relevant email/messaging content. Embodiments disclosed herein to collect and evaluate recipient behavior to optimize email campaigns to provide relevant communication to the recipients.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the information processing system 100. For example, containers can be used to implement respective processing devices providing compute and/or storage services of a cloud-based system. Again, containers may be used in combination with other virtualization infrastructure such as virtual machines implemented using a hypervisor.

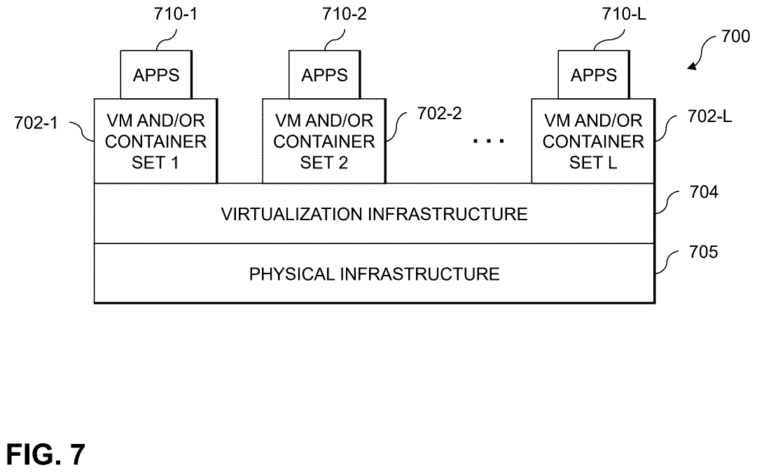

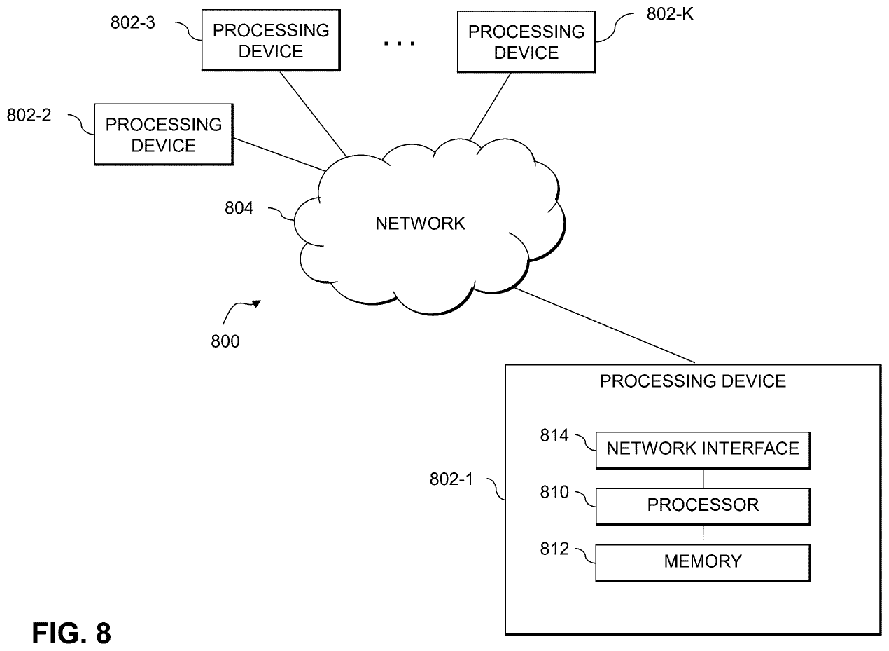

Illustrative embodiments of processing platforms will now be described in greater detail with reference to FIGS. 7 and 8. Although described in the context of the information processing system 100, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that are utilized to implement at least a portion of the information processing system 100. The cloud infrastructure 700 comprises multiple virtual machines (VMs) and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 comprise respective VMs, respective sets of one or more containers, or respective sets of one or more containers running in VMs. In some implementations of the FIG. 7 embodiment, the VMs/container sets 702 comprise respective VMs implemented using virtualization infrastructure 704 that comprises at least one hypervisor.

A hypervisor platform may be used to implement a hypervisor within the virtualization infrastructure 704, where the hypervisor platform has an associated virtual infrastructure management system. The underlying physical machines comprise one or more distributed processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of the information processing system 100 may each run on a computer, server, storage device or other processing platform element. A given such element is viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises a portion of the information processing system 100 and includes a plurality of processing devices, denoted 802-1, 802-2, 802-3, . . . 802-K, which communicate with one another over a network 804.

The network 804 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 802-1 in the processing platform 800 comprises a processor 810 coupled to a memory 812.

The processor 810 comprises a microprocessor, a microcontroller, an application-specific integrated circuit (ASIC), a field-programmable gate array (FPGA) or other type of processing circuitry, as well as portions or combinations of such circuitry elements.

The memory 812 comprises random access memory (RAM), read-only memory (ROM) or other types of memory, in any combination. The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and the information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
intercepting, in real-time by distributed email targeting system architecture, by an email server system, from an email client system, an email campaign intended for a plurality of recipients before transmission to the recipients wherein the intercepting comprises monitoring email transmission queues and redirecting identified email campaigns to the email targeting system while maintaining original transmission timing parameters;
categorizing, by an email targeting system executing machine learning algorithms in real-time during the interception process, each of the plurality of recipients into recipient behavior classifications based on previous recipient behavior responding to previous email campaigns wherein the categorizing comprises executing machine learning algorithms that analyze behavioral patterns and generate classifications, wherein the categorizing comprises compiling user data including geographic location data and average email reading time associated with the previous email campaigns;
dynamically generating, by the email targeting system in real-time during a single intercept-analyze-generate cycle, a personalized templated email communication for each of recipient behavior classifications, to replace the email campaign, wherein the email targeting system simultaneously uses the email campaign, a large language model, and the recipient behavior classifications to generate the personalized templated email communication, wherein the dynamically generating comprises: providing the large language model with the email campaign; prompting the large language model to generate a more concise email campaign; prompting the large language model to generate a more verbose email campaign; prompting the large language model to generate a strongly worded email header for the email campaign; and prompting the large language model to generate a general email header for the email campaign; and
transmitting the personalized templated email communications to the recipients within a predetermined time threshold of the original email campaign transmission schedule, wherein the method is performed by at least one processing device comprising a processor coupled to a memory and wherein the email targeting system comprises distributed processing components including a real-time interception module, a behavioral analysis engine, and a large language model interface that operate concurrently.

2. The method of claim 1 wherein the previous recipient behavior is associated with the plurality of recipients.

3. The method of claim 1 wherein intercepting in real-time by the email server system, from the email client system, the email campaign comprises:
monitoring email transmission queues in real-time;
identifying email campaigns based on predetermined criteria before transmission initiation; and
redirecting identified email campaigns to the email targeting system for processing while maintaining original transmission timing parameters.

4. The method of claim 1 wherein categorizing, by the email targeting system, each of the plurality of recipients into the recipient behavior classifications comprises:
compiling, by the email targeting system, message analytics, wherein the message analytics comprise at least one of read receipts and sent receipts associated with the previous email campaigns.

5. The method of claim 1 wherein categorizing, by the email targeting system, each of the plurality of recipients into the recipient behavior classifications comprises:
compiling, by the email targeting system, user data, wherein the user data comprises at least one of geographic location data and average email reading time associated with the previous email campaigns.

6. The method of claim 1 wherein categorizing, by the email targeting system, each of the plurality of recipients into the recipient behavior classifications comprises:
identifying, by the email targeting system, unique footprints in metadata associated with the previous email campaigns.

7. The method of claim 1 wherein categorizing, by the email targeting system, each of the plurality of recipients into the recipient behavior classifications comprises:
compiling, by the email targeting system, historical data associated with the previous email campaigns.

8. The method of claim 1 wherein categorizing, by the email targeting system, each of the plurality of recipients into the recipient behavior classifications comprises:
categorizing the plurality of recipients according to at least one of an opening classification and a reading classification.

9. The method of claim 1 wherein categorizing, by the email targeting system, each of the plurality of recipients into the recipient behavior classifications comprises:
categorizing, by the email targeting system, the plurality of recipients according to an opening classification, wherein the opening classification indicates how likely a recipient is to open an email relative to other recipients, wherein the opening classification comprises a mostly-ignores-email classification, a sometimes-ignores-email classification, and a usually-opens-email classification.

10. The method of claim 9 further comprising:
for each email in a plurality of email campaigns received by a recipient, wherein the plurality of recipients comprises the recipient:
determining whether the recipient opened the each email;
determining a percentage of opened emails for recipients receiving email from the plurality of email campaigns, based on geographical data associated with the recipient;
determining how much time the recipient spent reading the each email;
determining an average time spent reading the each email by the recipients receiving email from the plurality of email campaigns; and
recording a non-opened-email value if the recipient did not open the each email.

11. The method of claim 10 further comprising:
classifying the recipient as having ignored the each email based on whether the recipient opened the each email and the percentage of opened emails for the recipients receiving email from the plurality of email campaigns, based on the geographical data associated with the recipient.

12. The method of claim 10 further comprising:
classifying the recipient in one of the opening classifications based on whether the recipient opened the each email and the percentage of opened emails for the recipients receiving email from the plurality of email campaigns, based on the geographical data associated with the recipient.

13. The method of claim 1 wherein categorizing, by the email targeting system, each of the plurality of recipients into the recipient behavior classifications comprises:
categorizing by the email targeting system, the plurality of recipients according to a reading classification, wherein the reading classification indicates how much time a recipient typically spends reading an email relative to other recipients, wherein the reading classification comprises a minimal time reading classification, an average time reading classification, and an extra time reading classification.

14. The method of claim 13 wherein categorizing by the email targeting system, the plurality of recipients according to a reading classification comprises:
determining a standard deviation associated with the recipient's reading time for the each email in a plurality of email campaigns opened by the recipient; and
classifying the recipient into the reading classification according to the standard deviation.

15. (canceled)

16. The method of claim 1 further comprising:
for each recipient in the plurality of recipient categorized by the email targeting system with an opening classification of mostly-ignores-email classification, append the strongly worded email header; and
for each recipient in the plurality of recipient categorized by the email targeting system with an opening classification of sometimes-ignores-email classification, or usually-opens-email classification, append the general email header.

17. The method of claim 1 further comprising:
for each recipient in the plurality of recipient categorized by the email targeting system with a reading classification of minimal time reading classification, append the more concise email campaign; and
for each recipient in the plurality of recipient categorized by the email targeting system with a reading classification of extra time reading classification, append the more verbose email campaign.

18. The method of claim 1 further comprising:
transmitting, by the email targeting system, the personalized templated email communications back to the email client system for review by at least one author of the email campaign.

19. A system comprising:
at least one processing device comprising a processor coupled to a memory;
the at least one processing device being configured:
to intercept, in real-time by distributed email targeting system architecture, by an email server system, from an email client system, an email campaign intended for a plurality of recipients before transmission to the recipients wherein the intercepting comprises monitoring email transmission queues and redirecting identified email campaigns to the email targeting system while maintaining original transmission timing parameters;
to categorize, by an email targeting system executing machine learning algorithms in real-time during the interception process, each of the plurality of recipients into recipient behavior classifications based on previous recipient behavior responding to previous email campaigns wherein the categorizing comprises executing machine learning algorithms that analyze behavioral patterns and generate classifications, wherein the categorizing comprises compiling user data including geographic location data and average email reading time associated with the previous email campaigns;
to dynamically generate, by the email targeting system in real-time during a single intercept-analyze-generate cycle, a personalized templated email communication for each of recipient behavior classifications, to replace the email campaign, wherein the email targeting system simultaneously uses the email campaign, a large language model, and the recipient behavior classifications to generate the personalized templated email communication, wherein the dynamically generating comprises: providing the large language model with the email campaign; prompting the large language model to generate a more concise email campaign; prompting the large language model to generate a more verbose email campaign; prompting the large language model to generate a strongly worded email header for the email campaign; and prompting the large language model to generate a general email header for the email campaign; and
to transmit the personalized templated email communications to the recipients within a predetermined time threshold of the original email campaign transmission schedule, wherein the email targeting system comprises distributed processing components including a real-time interception module, a behavioral analysis engine, and a large language model interface that operate concurrently.

20. A computer program product comprising a non-transitory processor-readable storage medium having stored therein program code of one or more software programs, wherein the program code when executed by at least one processing device causes said at least one processing device:
to intercept, in real-time by distributed email targeting system architecture, by an email server system, from an email client system, an email campaign intended for a plurality of recipients before transmission to the recipients wherein the intercepting comprises monitoring email transmission queues and redirecting identified email campaigns to the email targeting system while maintaining original transmission timing parameters;
to categorize, by an email targeting system executing machine learning algorithms in real-time during the interception process, each of the plurality of recipients into recipient behavior classifications based on previous recipient behavior responding to previous email campaigns wherein the categorizing comprises executing machine learning algorithms that analyze behavioral patterns and generate classifications, wherein the categorizing comprises compiling user data including geographic location data and average email reading time associated with the previous email campaigns;
to dynamically generate, by the email targeting system in real-time during a single intercept-analyze-generate cycle, a personalized templated email communication for each of recipient behavior classifications, to replace the email campaign, wherein the email targeting system simultaneously uses the email campaign, a large language model, and the recipient behavior classifications to generate the personalized templated email communication, wherein the dynamically generating comprises: providing the large language model with the email campaign; prompting the large language model to generate a more concise email campaign; prompting the large language model to generate a more verbose email campaign; prompting the large language model to generate a strongly worded email header for the email campaign; and prompting the large language model to generate a general email header for the email campaign; and
to transmit the personalized templated email communications to the recipients within a predetermined time threshold of the original email campaign transmission schedule, wherein the email targeting system comprises distributed processing components including a real-time interception module, a behavioral analysis engine, and a large language model interface that operate concurrently.
